(19) United States
(12) Patent Application Publication
(10) Pub. No.: US 2026/0323706 A1
(43) Pub. Date: Oct. 15, 2026

(54) EARLY TERMINATION OF RANDOM ACCESS RESPONSE DECODING

(71) Applicant: QUALCOMM Incorporated, San Diego, CA (US)

(72) Inventors: Jing LEI, San Diego, CA (US); Ruiming ZHENG, Beijing (CN); Peter GAAL, San Diego, CA (US)

(21) Appl. No.: 19/109,378

(22) PCT Filed: Oct. 18, 2022
(86) PCT No.: PCT/CN2022/125843

§ 371 Date: Mar. 6, 2025

(51) Int. Cl. H04W 74/0833; H04W 74/00

(52) U.S. Cl. CPC H04W 74/0833; H04W 74/006

(57) ABSTRACT

Various aspects of the present disclosure generally relate to wireless communication. In some aspects, a user equipment (UE) may receive an indication of whether a random access response (RAR) is for a first UE type, a second UE type, or both the first UE type and the second UE type. The UE may decode, or skipping decoding of, the RAR in accordance with the indication and based at least in part on whether the UE is associated with the first UE type or the second UE type. Numerous other aspects are described.

### FIELD OF THE DISCLOSURE

Aspects of the present disclosure generally relate to wireless communication and to techniques and apparatuses for early termination of random access response (RAR) decoding.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

Some aspects described herein relate to a method of wireless communication performed by a user equipment (UE). The method may include receiving an indication of whether a random access response (RAR) is for a first UE type, a second UE type, or both the first UE type and the second UE type. The method may include decoding, or skipping decoding of, the RAR in accordance with the indication and based at least in part on whether the UE is associated with the first UE type or the second UE type.

Some aspects described herein relate to a method of wireless communication performed by a network entity. The method may include outputting an indication of whether an RAR is for a first UE type, a second UE type, or both the first UE type and the second UE type. The method may include outputting the RAR associated with a UE in accordance with the indication and based at least in part on whether the UE is associated with the first UE type or the second UE type.

Other aspects provide: an apparatus operable, configured, or otherwise adapted to perform any one or more of the aforementioned methods and/or those described herein with reference to and as illustrated by the drawings; a non-transitory, computer-readable media comprising processor-executable instructions that, when executed by a processor of an apparatus, cause the apparatus to perform the aforementioned methods as well as those described herein with reference to and as illustrated by the drawings; a computer program product embodied on a computer-readable storage medium comprising code for performing the aforementioned methods as well as those described herein with reference to and as illustrated by the drawings; and/or an apparatus comprising means for performing the aforementioned methods. as well as those described herein with reference to and as illustrated by the drawings. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station and user equipment (UE), in accordance with the present disclosure.

FIG. 3 depicts an example disaggregated base station architecture.

FIGS. 4A, 4B, 4C, and 4D depict aspects of data structures for a wireless communications network, in accordance with the present disclosure.

FIG. 5 is a diagram illustrating an example of a two-step random access procedure, in accordance with the present disclosure.

FIG. 6 is a diagram illustrating an example of a four-step random access procedure, in accordance with the present disclosure.

FIG. 7 is a diagram illustrating an example of a physical downlink control channel (PDCCH) communication scheduling a physical downlink shared channel (PDSCH) communication carrying a random access response (RAR), in accordance with the present disclosure.

FIG. 8 is a diagram of an example of signaling for indication of whether a RAR is for a first UE type or a second UE type, in accordance with the present disclosure.

FIG. 9 is a diagram illustrating examples of indication of a UE type of an RAR via radio network temporary identifier (RNTI) differentiation, in accordance with the present disclosure.

FIG. 10 is a diagram illustrating an example of indication of a UE type for an RAR by RAR window differentiation, in accordance with the present disclosure.

FIG. 11 shows a method for wireless communications by a UE, in accordance with the present disclosure.

FIG. 12 shows a method for wireless communications by a network entity, in accordance with the present disclosure.

FIG. 13 depicts aspects of an example communications device, in accordance with the present disclosure.

FIG. 14 depicts aspects of an example communications device, in accordance with the present disclosure.

### DETAILED DESCRIPTION

Aspects of the present disclosure provide apparatuses, methods, processing systems, and computer-readable mediums for early termination of random access response (RAR) decoding.

Different devices may have different capabilities and/or features. For example, different user equipment (UEs) using a 5G radio access technology (RAT) may have different sets of capabilities and/or features. A UE having a particular set of capabilities and/or features may be considered to have a certain UE type. Different UEs may have different UE types. For example, UEs having a first UE type may have a first capability, such as a first capability for a radio frequency (RF) bandwidth and/or a baseband (BB) bandwidth, and UEs having a second UE type may have a second capability, such as a second capability for an RF bandwidth and/or a BB bandwidth. In some aspects, UEs having the first UE type may be referred to as enhanced mobile broadband (eMBB) UEs or reduced capability (RedCap) UEs, and UEs having the second UE type may be referred to as enhanced RedCap (eRedCap) UEs. The differentiation of UEs by UE type may enable the deployment of different classes of UEs, such as UEs providing support for more sophisticated features of NR (such as a user-facing smartphone) as well as UEs providing relative low cost, energy consumption, and data rate requirements (such as industrial wireless sensors, wearables, surveillance devices, and so on).

There are situations in which UEs of a first UE type may be capable of decoding a communication and UEs of a second UE type may not be capable of decoding the communication. For example, the communication may have a bandwidth that exceeds a capability of the second UE type and is within a capability of the first UE type. Furthermore, if a UE of the first UE type decodes a communication that is directed to a UE of the second UE type (such that the communication conforms to the second UE type's less sophisticated capabilities), then power and decoding resources of the UE of the first type may be inefficiently utilized. One example of such a communication is an RAR. An RAR may be scheduled by downlink control information (DCI) received via a physical downlink control channel (PDCCH). The UE may first receive the DCI and may then receive the RAR. However, in some configurations, there can be ambiguity as to whether an RAR is directed to a UE having a first UE type or a UE having a second UE type. If a bandwidth of the RAR exceeds a bandwidth capability of the second UE type, then the UE having the second UE type may be incapable of decoding the RAR and may thus use power and decoding resources. If the bandwidth of the RAR is within the bandwidth capability of the second UE type and is directed to a UE of the second UE type, then a UE of the first UE type may use power and decoding resources to erroneously decode the RAR.

Some techniques described herein provide early termination of decoding of an RAR. As used herein, “early termination” may refer to skipping (e.g., canceling, ending) decoding of an RAR or information provided in the RAR prior to completion of decoding of the RAR. For example, the UE may terminate decoding of the RAR according to an indication of whether the RAR is associated with a UE type of the UE or not. The indication can take various forms, as described elsewhere herein. The indication may allow the UE to skip decoding of the RAR entirely, or to terminate decoding of the RAR prior to completing decoding of the RAR. Thus, power and decoding resources of a UE are conserved (such as in the case where the RAR exceeds the capabilities of the UE or in the case where the RAR is not directed to the UE).

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) RAT, aspects of the present disclosure can be applied to other RATs, such as a 3G RAT, a 4G RAT, and/or a RAT subsequent to 5G (e.g., 6G).

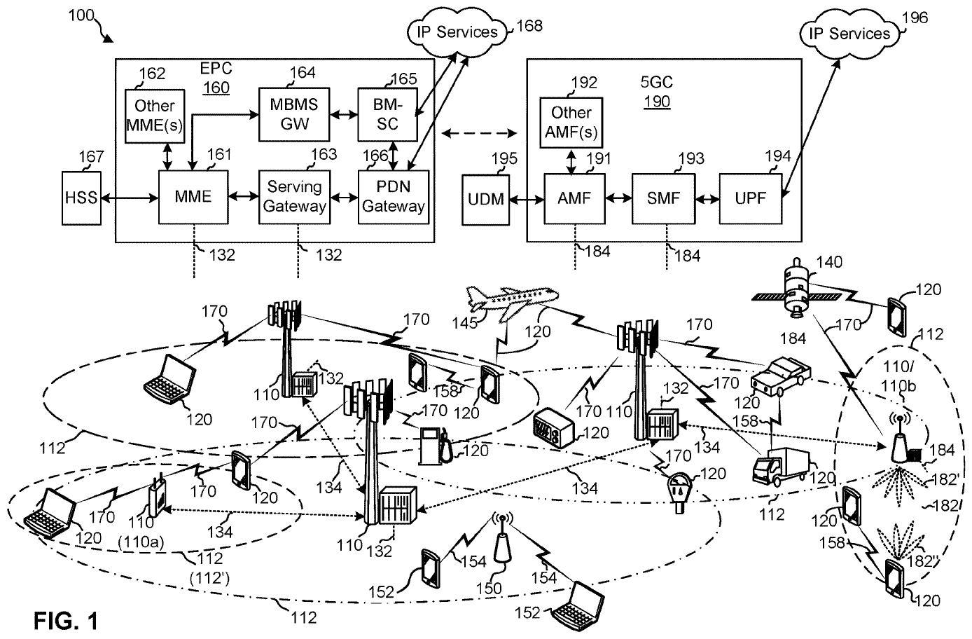

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IOT) device, always on (AON) device, edge processing device, or another similar device. A UE 120 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

BSs 110 may generally include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

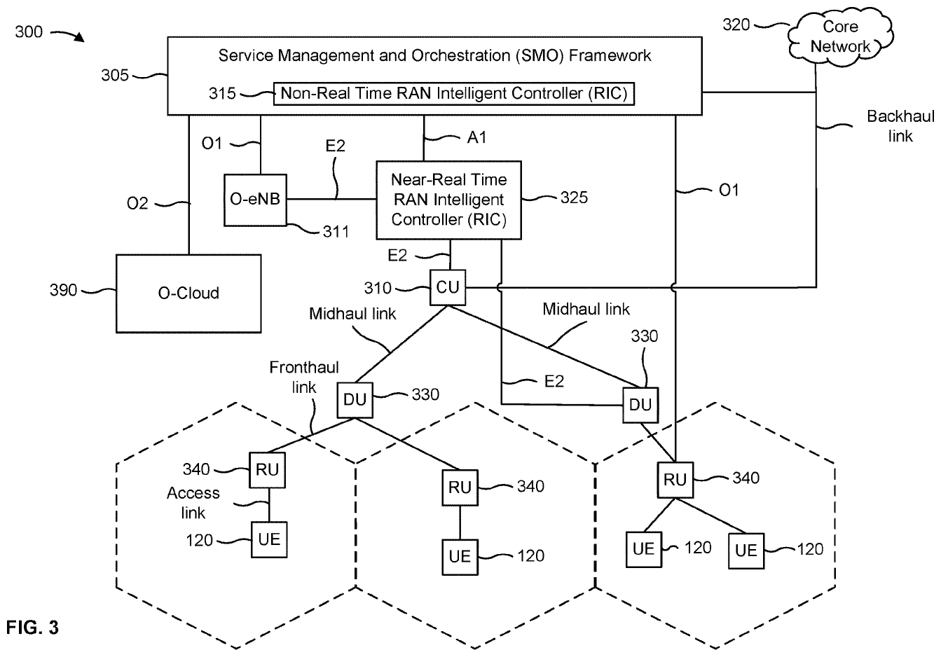

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 110) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 3 depicts and describes an example disaggregated base station architecture.

Different BSs 110 within wireless communications network 100 may also be configured to support different radio access technologies, such as 3G, 4G, and/or 5G. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the 3rd Generation Partnership Project (3GPP) currently defines Frequency Range 1 (FR 1) as including 410 MHz-7125 MHz, which is often referred to (interchangeably) as “Sub-6 GHz”. Similarly, 3GPP currently defines Frequency Range 2 (FR 2) as including 24,250 MHz-52,600 MHz, which is sometimes referred to (interchangeably) as a “millimeter wave” (“mmW” or “mmWave”). A base station configured to communicate using mm Wave or near mm Wave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is the control node that processes the signaling between the UEs 120 and the EPC 160. Generally, MME 161 provides bearer and connection management.

Generally, user Internet protocol (IP) packets are transferred through Serving Gateway 163, which itself is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may be used to distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QOS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, or a transmission reception point (TRP), to name a few examples.

As indicated above, FIG. 1 is provided as an example. Other examples may differ from what is described with regard to FIG. 1.

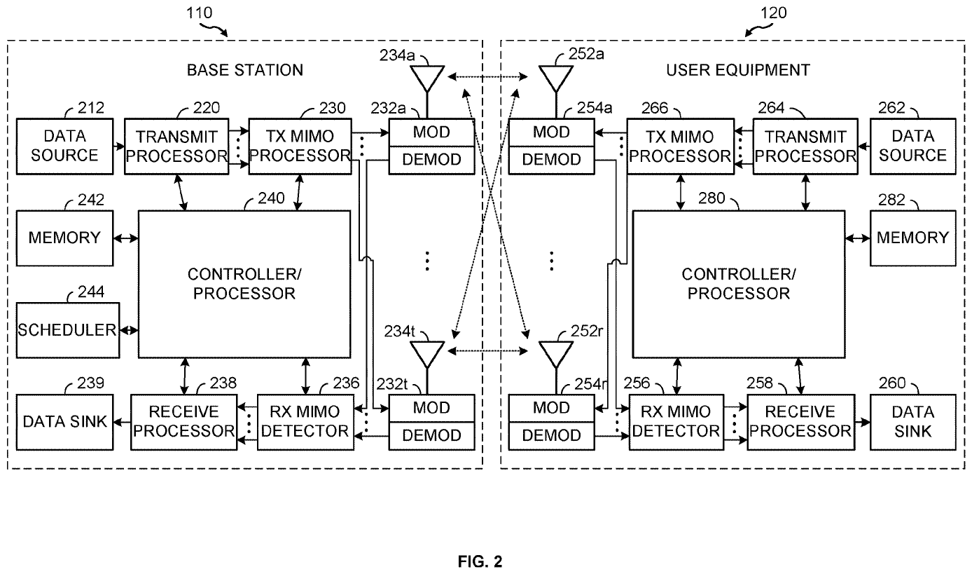

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

In regard to an example downlink transmission, BS 110 includes a transmit processor 220 that may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), PDCCH, group common PDCCH (GC PDCCH), and/or others. The data may be for the physical downlink shared channel (PDSCH), in some examples.

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) MIMO processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

In order to receive the downlink transmission, UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

In regard to an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 110.

At BS 110, the uplink signals from UE 120 may be received by antennas 234a-t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, RX MIMO detector 236, controller/processor 240, receive processor 238, scheduler 244, memory 242, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more CUs 310 that can communicate directly with a core network 320 via a backhaul link, or indirectly with the core network 320 through one or more disaggregated base station units (such as a Near-Real Time (Near-RT) RIC 325 via an E2 link, or a Non-Real Time (Non-RT) RIC 315 associated with a Service Management and Orchestration (SMO) Framework 305, or both). A CU 310 may communicate with one or more DUs 330 via respective midhaul links, such as an F1 interface. The DUs 330 may communicate with one or more RUs 340 via respective fronthaul links. The RUs 340 may communicate with respective UEs 120 via one or more RF access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing processor-executable instructions to the communications interfaces of the units, can be configured to communicate with one or more of the other units via the transmission medium. For example, the units can include a wired interface configured to receive or transmit signals over a wired transmission medium to one or more of the other units. Additionally, or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the El interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3GPP. In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

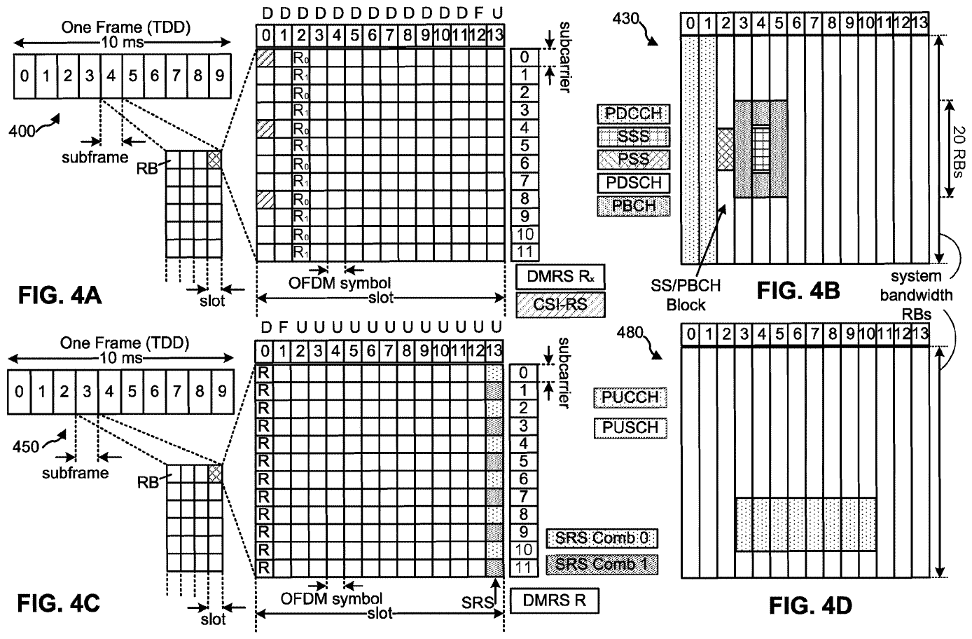

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also use TDD, in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DCI, or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 24 slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSs) for a UE (e.g., UE 120). The RSs may include DMRSs and/or CSI-RSs for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The PDCCH carries DCI within one or more control channel elements (CCEs), each CCE including, for example, nine RE groups (REGs), each REG including, for example, four consecutive REs in an OFDM symbol.

A PSS may be within symbol 2 of particular subframes of a frame. The PSS is used by a UE (e.g., UE 120) to determine subframe/symbol timing and a physical layer identity.

An SSS may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (also referred to as an SS block (SSB)). The MIB provides a number of RBs in the system bandwidth and a system frame number (SFN). The PDSCH carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit SRSs. The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK or negative acknowledgement (NACK) (ACK/NACK) feedback. The PUSCH carries data, and may additionally be used to carry a buffer status report (BSR), a power headroom report (PHR), and/or UCI.

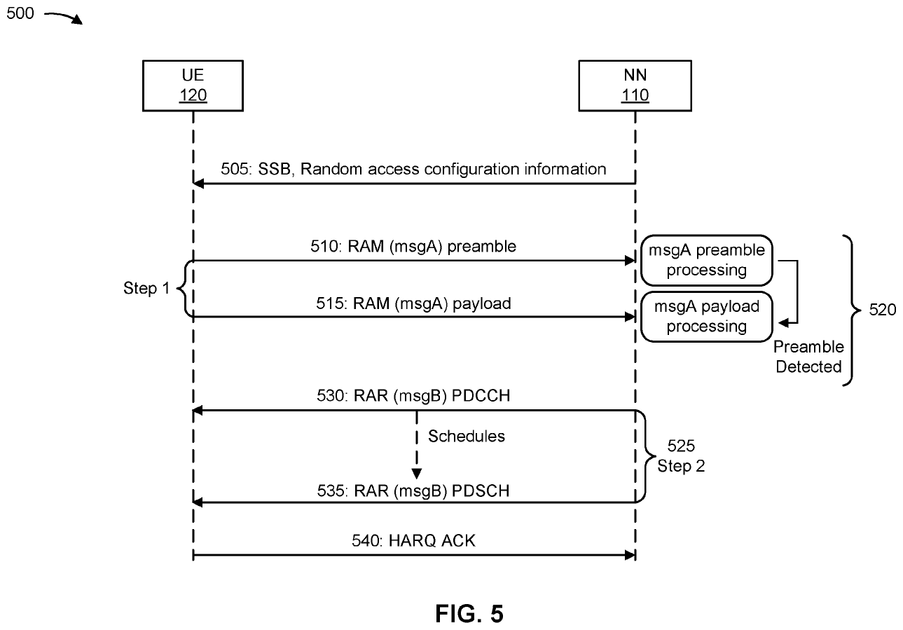

FIG. 5 is a diagram illustrating an example 500 of a two-step random access procedure, in accordance with the present disclosure. As shown in FIG. 5, a BS 110 and a UE 120 may communicate with one another to perform the two-step random access procedure.

As shown by reference number 505, the BS 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a random access channel (RACH) procedure, such as for contention-free random access. The random access configuration information may include one or more parameters to be used in the two-step random access procedure, such as one or more parameters for transmitting a random access message (RAM) and/or receiving an RAR to the RAM.

As shown by reference number 510, the UE 120 may transmit, and the network entity 110 may receive, a RAM preamble. As shown by reference number 515, the UE 120 may transmit, and the BS 110 may receive, a RAM payload. As shown, the UE 120 may transmit the RAM preamble and the RAM payload to the BS 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 520, the BS 110 may receive the RAM preamble transmitted by the UE 120. If the BS 110 successfully receives and decodes the RAM preamble, the BS 110 may then receive and decode the RAM payload.

As shown by reference number 525, the BS 110 may transmit an RAR (sometimes referred to as an RAR message). As shown, the BS 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 530, as part of the second step of the two-step random access procedure, the BS 110 may transmit a PDCCH communication for the RAR. The PDCCH communication may schedule a PDSCH communication that includes the RAR. For example, the PDCCH communication may indicate a resource allocation (e.g., in DCI) for the PDSCH communication.

As shown by reference number 535, as part of the second step of the two-step random access procedure, the BS 110 may transmit the PDSCH communication for the RAR, as scheduled by the PDCCH communication. The RAR may be included in a MAC protocol data unit (PDU) of the PDSCH communication. As shown by reference number 540, if the UE 120 successfully receives the RAR, the UE 120 may transmit a HARQ acknowledgement (ACK).

As indicated above, FIG. 5 is provided as an example. Other examples may differ from what is described with regard to FIG. 5.

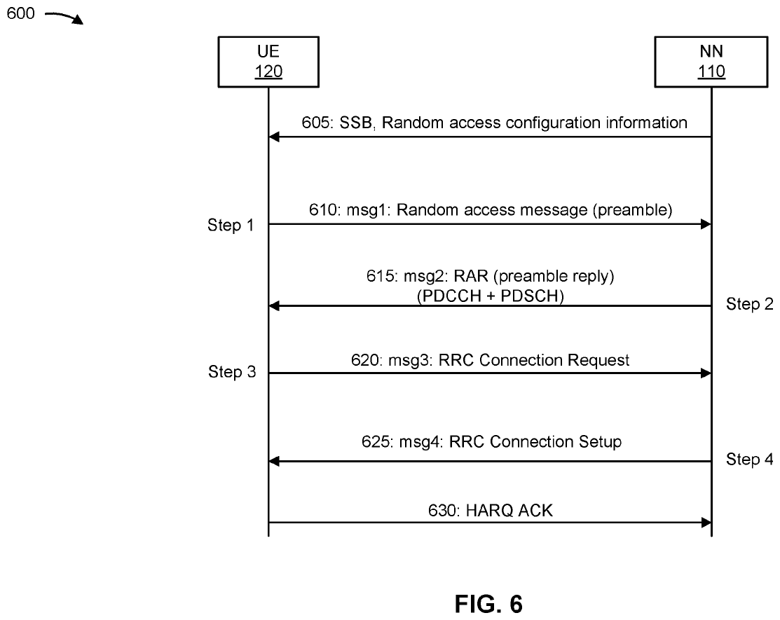

FIG. 6 is a diagram illustrating an example of a four-step random access procedure, in accordance with the present disclosure. As shown in FIG. 6, a BS 110 and a UE 120 may communicate with one another to perform the four-step random access procedure.

As shown by reference number 605, the BS 110 may transmit, and the UE 120 may receive, one or more SSBs and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in a RRC message and/or a PDCCH order message that triggers a RACH procedure, such as for contention-free random access.

The random access configuration information may include one or more parameters to be used in the random access procedure, such as one or more parameters for transmitting a RAM and/or one or more parameters for receiving an RAR.

As shown by reference number 610, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 615, the BS 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the BS 110 may transmit a PDCCH communication for the RAR. The PDCCH communication may schedule a PDSCH communication that includes the RAR. For example, the PDCCH communication may indicate a resource allocation for the PDSCH communication. Also, as part of the second step of the four-step random access procedure, the BS 110 may transmit the PDSCH communication for the RAR, as scheduled by the PDCCH communication. The RAR may be included in a MAC PDU of the PDSCH communication.

As shown by reference number 620, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 625, the BS 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 630, if the UE 120 successfully receives the RRC connection setup message, the UE 120 may transmit a HARQ ACK.

As indicated above, FIG. 6 is provided as an example. Other examples may differ from what is described with regard to FIG. 6.

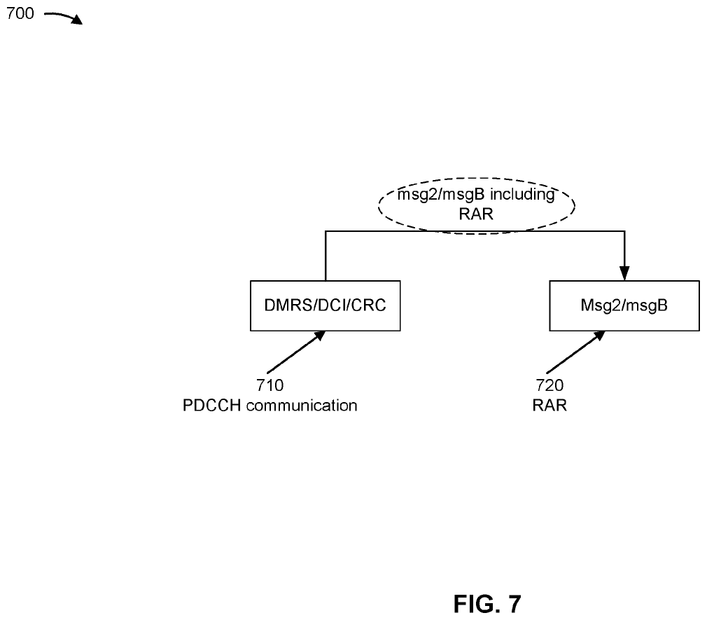

FIG. 7 is a diagram illustrating an example 700 of a PDCCH communication 710 scheduling a PDSCH communication carrying an RAR 720, in accordance with the present disclosure. As shown, the PDCCH communication may include a DMRS. A DMRS is a reference signal used to demodulate a PDCCH communication. As further shown, the PDCCH communication may carry DCI. The DCI may include scheduling information that schedules a PDSCH communication carrying an RAR 720. The DCI may be encoded using a cyclic redundancy check (CRC). A CRC is a value generated using an error detecting code (e.g., a cyclic code). A CRC may be generated based at least in part on the content of a block of data (e.g., DCI, an encoded version of DCI) and may be appended to the block of data. The RAR 720 may include, for example, a RACH msg2 (described in connection with FIG. 5) or a RACH msgB (described in connection with FIG. 6). In some aspects, UEs of the first UE type and the second UE type may be configured with initial bandwidth part (BWP) resources (e.g., downlink and uplink BWP resources) and random access resources (including PRACH occasions, CORESET(s), and/or a common search space) overlapping or partially overlapping in the time and/or frequency domain.

This disclosure describes UEs of a first UE type and a second UE type. UEs of a first UE type may have a first capability (e.g., a first bandwidth capability, among other examples) and UEs of a second UE type may have a second capability (e.g., a second bandwidth capability, among other examples). In some aspects, the first UE type may include eMBB UEs and/or RedCap UEs. In some aspects, the second UE type may include eRedCap UEs. In some aspects, the first UE type may have an RF bandwidth capability of at least 20 MHz for uplink and downlink communications. An RF bandwidth capability may indicate a maximum bandwidth of a BWP or carrier (e.g., a maximum configurable initial bandwidth) of the first UE type. In some aspects, a RedCap UE (of the first UE type) or an eRedCap UE (of the second UE type) may be configurable with an initial RF bandwidth of up to 20 MHz. In some aspects, the second UE type may have a BB bandwidth capability of 5 MHz for PDSCHs (e.g., for unicast and broadcast) and for PUSCHs. A BB bandwidth capability may indicate a maximum bandwidth or a supported bandwidth for a particular channel or communication at the baseband. In some aspects, for physical channels and signals other than the PDSCH and the PUSCH, the second UE type may have a BB bandwidth capability equal to the RF bandwidth capability. In some aspects, the first UE type may be referred to as a legacy UE type and the second UE type may be referred to as an eRedCap UE type.

In some aspects, UEs of the first UE type and UEs of the second UE type may share a cell-defining SSB (CD-SSB) and a control resource set #0 (CORESET #0) with one another. For example, UEs of the first UE type and UEs of the second UE type may both identify system information block 1 (SIB1) using a same CD-SSB, and may receive a PDCCH communication defining a resource for a PDSCH communication carrying SIB1 by monitoring the same CORESET #0.

A RACH occasion (RO) is a set of time and frequency locations available for a UE to transmit a RACH preamble. In some aspects, a UE of a first UE type may share RACH occasions with a UE of a second UE type, such that the UE of the first UE type and the UE of the second UE type may both monitor for DCI (scheduling a PDSCH communication for an RAR) addressed to a same random access radio network temporary identifier (RNTI) (RA-RNTI) or a same message-B RNTI. For example, the RA-RNTI or the message-B RNTI may be a function of RACH occasion and/or one or more other factors. In this example, different UE types may be configured with different groups of preamble sequences. Thus, the different UE types can be differentiated via orthogonal preamble sequence resources (e.g., code division multiplexing) for purposes of providing an RAR in response to a RAM. However, since the UE of the first UE type and the UE of the second UE type share RACH occasions, it may be difficult to distinguish RARs for the UE of the first UE type from RARs for the UE of the second type until decoded. If a bandwidth of an RAR exceeds a capability of the second UE type, then the RAR may be decodable by only the first UE type, which uses decoding resources of the second UE type for no benefit. If the RAR is within the capabilities of the first UE type and the second UE type, the RAR may still be indistinguishable as targeted to the first UE type or the second UE type. For example, a UE of the first UE type may use power to decode an RAR targeting only a UE of the second UE type, or a UE of the second UE type may use power to decode an RAR targeting only a UE of the first UE type. Some techniques described herein provide an indication, such as in the association with the PDCCH communication 710 or another form of signaling, of whether an RAR is for a first UE type or a second UE type. The indication may enable a UE to selectively decode, or skip decoding of, an RAR according to whether the UE is a UE of the first UE type, the second UE type, or both.

While the techniques described herein are applicable for RACH, these techniques can be applied for procedures that involve random access, such as random access based procedures (such as small data transfer)

In some aspects, the indication may be, may be associated with, or may be included in the PDCCH communication 710. For example, the PDCCH communication 710 may be addressed to an RA-RNTI and/or a messageB-RNTI. In some aspects, the indication may comprise a DMRS of the PDCCH communication 710 associated with the RAR. For example, the DMRS may be generated using (and/or be configured with) a scrambling identifier (e.g., via system information) that indicates a UE type of the RAR. As another example, the DMRS may be generated using (and/or configured with) a pseudo-sequence (that is, a pseudo-random sequence), which may be indicated by system information or a wireless communication specification, that indicates a UE type of the RAR. As another example, the DMRS may be mapped to (e.g., transmitted and received on) a resource element pattern that indicates a UE type of the RAR, where the resource element pattern is indicated by system information or a wireless communication specification.

The PDCCH communication 710 may be considered “associated with” the RAR because the PDCCH communication 710 carries DCI scheduling the RAR. The DCI may be considered “associated with” the RAR because the DCI schedules a PDSCH communication that carries the RAR.

In some aspects, the indication may include a CRC of the DCI. For example, a CRC attachment of the DCI may use a pattern that indicates a UE type of the RAR, wherein the pattern may be indicated by system information or a wireless communication specification.

In some aspects, the indication may include a field of the DCI. For example, one or more fields in the DCI may be scrambled by or interleaved with a sequence (e.g., indicated by system information or a wireless communication specification) that indicates a UE type of the RAR. As another example, one or more fields in the DCI may be configured with (or may include) a bitwidth (e.g., a range of transport block scaling, a start and length indicator (SLIV) table indication, a range for a time domain resource assignment, a range of modulation and coding schemes) that indicates a UE type of the RAR, wherein the bitwidth is indicated by system information or a wireless communication specification.

In some aspects, the indication may be or include a bit. For example, the bit may indicate the UE type of the RAR. In some aspects, the bit may be a bit that was a reserved bit, such as a bit that was reserved for operation in shared spectrum or a bit that was reserved for operation in unlicensed spectrum.

In some aspects, if a UE monitors a DCI addressed to a common RNTI (common between UEs of the first UE type and the second UE type), such as an RA-RNTI and/or a messageB-RNTI, the UE may skip decoding of an RAR scheduled by the DCI if the DCI can be decoded, but one or multiple fields in the DCI are not valid for the corresponding UE capability (e.g., if the frequency domain resource allocation for the PDSCH spans a bandwidth wider than is supported by a UE of the second UE type). In some aspects, if a UE monitors a DCI addressed to a common RNTI (common between UEs of the first UE type and the second UE type), such as an RA-RNTI and/or a messageB-RNTI, the UE may skip decoding of an RAR scheduled by the DCI if the DCI cannot be decoded by the UE (e.g., if there is a mismatch for CHEST, CRC, or the like).

In some aspects, the indication includes the PDCCH communication 710 in a CORESET that indicates whether the RAR is for the first UE type, the second UE type, or both. For example, a first CORESET or a first common search space may be configured for UEs of a first UE type, and a second CORESET or a second common search space may be configured for UEs of a second UE type. In this example, the first CORESET or the first common search space may have a first configuration (e.g., indicating the first CORESET or the first common search space as associated with the first UE type), and the second CORESET or the second common search space may have a second configuration (e.g., indicating the second CORESET or the second common search space as associated with the second UE type). For example, the first CORESET may be mapped to first frequency domain resources (e.g., one or more contiguous or non-contiguous RBs or RB groups), and the second CORESET may be mapped to second frequency domain resources (e.g., one or more contiguous or non-contiguous RBs or RB groups), where the first frequency domain resources are associated with the first UE type and the second frequency domain resources are associated with the second UE type. As another example, the first CORESET may be quasi co-located with a first set of SSB indexes and/or bursts (such as a CD-SSB or a non-CD-SSB (NCD-SSB)), and the second CORESET may be quasi co-located with a second set of SSB indexes and/or bursts.

In some aspects, the indication includes the PDCCH communication 710 in a search space or a search space set (e.g., a common search space (CSS) set) that indicates whether the RAR is for the first UE type, the second UE type, or both. For example, a first CSS set associated with the first UE type may be configured with a first set of parameters (e.g., aggregation level, time offset, periodicity, a combination thereof, and/or another parameter), and a second CSS set associated with the second UE type may be configured with a second set of parameters (e.g., aggregation level, time offset, periodicity, a combination thereof, and/or another parameter) different from the first set of parameters. These configurations may be indicated via system information. Thus, a UE can differentiate, according to whether a PDCCH communication 710 is received in the first CSS set or the second CSS set, whether the PDCCH communication 710 is associated with the first UE type, the second UE type, or both, and the UE can decode, or skip decoding of, a corresponding RAR.

By providing the indication in the PDCCH communication 710 or in association with the PDCCH communication 710, a UE can determine, prior to decoding whether the RAR, whether the RAR is directed to UEs of a UE type of the UE. Thus, the UE can selectively decode, or skip decoding of, the RAR, which improves utilization of power of the UE.

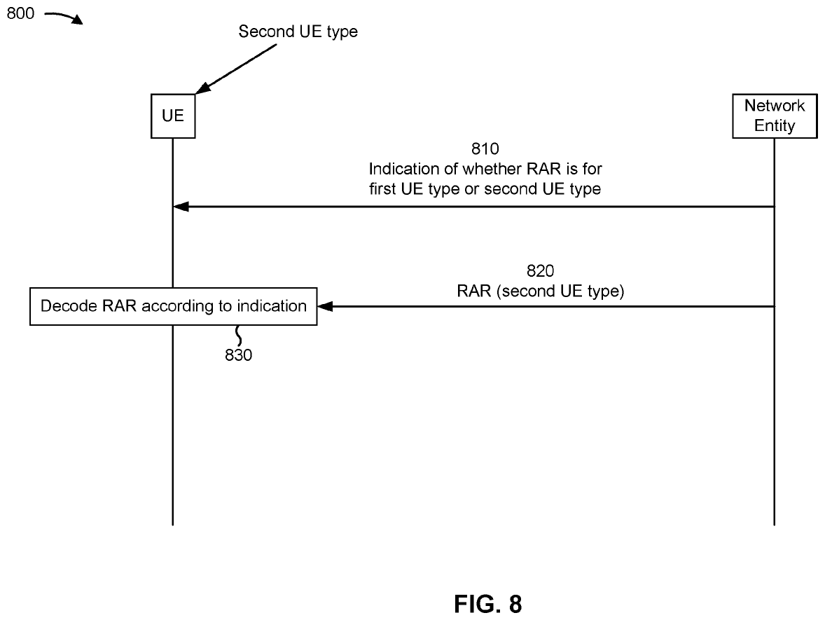

FIG. 8 is a diagram of an example 800 of signaling for indication of whether an RAR is for a first UE type or a second UE type, in accordance with the present disclosure. As shown, example 800 includes a UE (e.g., UE 120) and a network entity (e.g., base station 110, one or more network entities of a disaggregated base station). The UE may have a UE type, such as a first UE type or a second UE type described elsewhere herein. In example 800, the UE type is the second UE type (e.g., for an eRedCap UE).

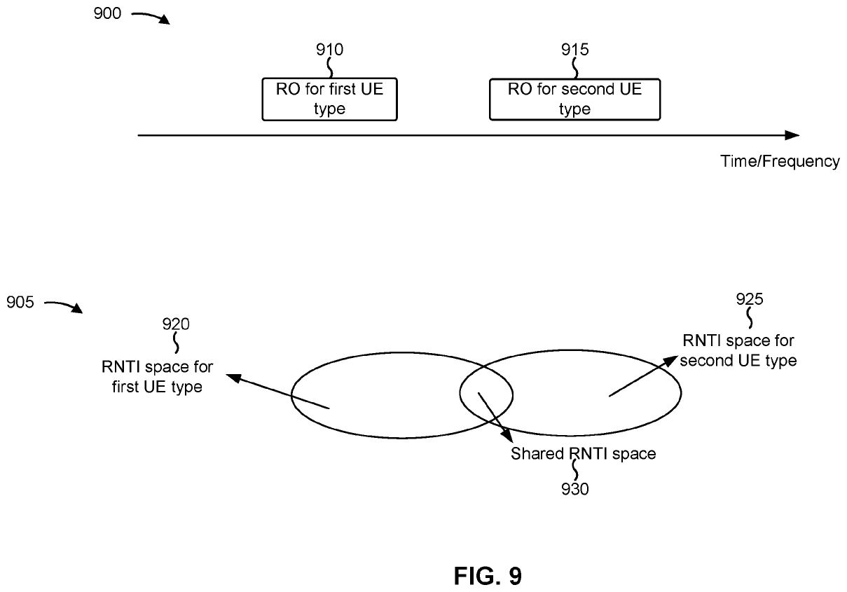

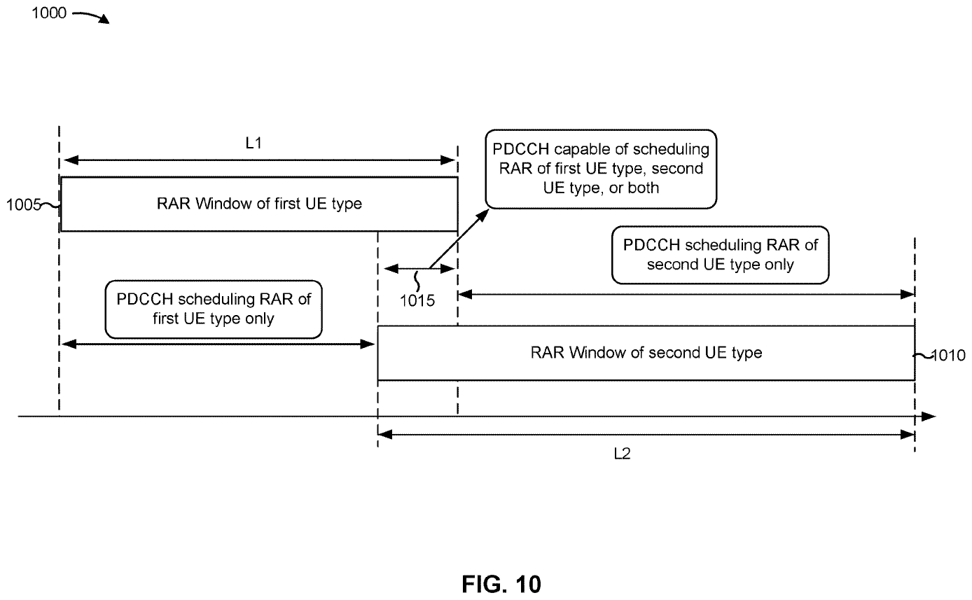

As shown by reference number 810, the network entity may output, and the UE may receive, an indication of whether an RAR is for a first UE type, a second UE type, or both the first UE type and the second UE type. In some aspects, the indication may be included in or associated with a PDCCH communication scheduling the RAR, such as a PDCCH communication 710 described in more detail with regard to FIG. 7. In some aspects, the indication may be, or may be included in, a configuration of a RACH occasion, as described with regard to examples 900 and 905 of FIG. 9. In some aspects, the indication may be included in a configuration of an RAR window, as described with regard to example 1000 of FIG. 10. In example 800, the indication indicates that a corresponding RAR (e.g., an RAR scheduled by a PDCCH communication or DCI that carries or is associated with the indication, an RAR on a downlink bandwidth part whose configuration includes the indication, an RAR having an RNTI that indicates a UE type for the RAR, an RAR in response to a RACH occasion that indicates a UE type for the RAR, or the like) is for the second UE type. For example, the indication may indicate that UEs of the second UE type are to decode the RAR.

In some aspects, the indication may include one or more parameters of a downlink BWP configuration for random access. For example, the network entity may provide an RRC configuration, or a DCI or MAC selection of an RRC configuration, indicating the downlink BWP configuration for random access. The downlink BWP configuration for random access may be a configuration of a BWP for reception of a RAM and/or a PDCCH communication of a RACH procedure. In some aspects, the one or more parameters may include a bandwidth. For example, a bandwidth parameter may indicate whether the downlink BWP configuration for random access is for the first UE type or the second UE type. In some aspects, the one or more parameters may include a starting PRB of the downlink PRB. For example, a starting PRB may indicate whether the downlink BWP configuration for random access is for the first UE type or the second UE type. In some aspects, the one or more parameters may include a scheduling offset (e.g., k0). For example, a scheduling offset may indicate whether the downlink BWP configuration for random access is for the first UE type or the second UE type. In some aspects, the one or more parameters may include a DCI format size of a PDCCH communication scheduling a RAM, as indicated by the downlink BWP configuration for random access. For example, a range in which the DCI format size is included may indicate whether the downlink BWP configuration for random access is for the first UE type or the second UE type. In some aspects, the one or more parameters may include an aggregation level for PDCCH monitoring in the downlink BWP configuration for random access. For example, a range in which the aggregation level occurs may indicate whether the downlink BWP configuration for random access is for the first UE type or the second UE type. In some aspects, the one or more parameters may include a time offset for PDCCH monitoring in the downlink BWP configuration for random access. For example, a range in which the time offset occurs may indicate whether the downlink BWP configuration for random access is for the first UE type or the second UE type. In some aspects, the one or more parameters may include a periodicity for PDCCH monitoring in the downlink BWP configuration for random access. For example, a range in which the periodicity occurs may indicate whether the downlink BWP configuration for random access is for the first UE type or the second UE type. In some aspects, the one or more parameters may include an indication of a BWP for a narrow-band PDSCH communication. For example, the BWP for the narrow-band PDSCH communication may be considered a fractional BWP (e.g., a fraction of the downlink BWP for random access) or a virtual BWP (e.g., a region of the downlink BWP for random access that is configured for a specific purpose via another BWP configuration) for a narrow-band PDSCH communication.

As shown by reference number 820, the network entity may output, and the UE may receive, an RAR. In some aspects, the RAR may include or be associated with the indication. For example, a RNTI of the RAR (e.g., a messageB-RNTI or a RA-RNTI) may include the indication. As shown by reference number 830, the UE may decode the RAR. For example, the UE may determine that the RAR is for the second UE type, and may decode the RAR in response to determining that the RAR is for the second UE type. In some aspects, the UE may determine that the RAR is for the first UE type. In such aspects, the UE may skip decoding of the RAR. For example, the UE may skip reception of the RAR. As another example, the UE may determine that an RNTI of the RAR indicates the first UE type, and may skip or cease decoding of the RAR in response to determining that the RNTI of the RAR indicates the first UE type. In this way, resources of the UE are conserved relative to attempting to decode the RAR irrespective of whether the RAR is directed to or compatible with a UE type of the UE. In some aspects, the UE may perform an action based at least in part on decoding the RAR. For example, the UE may perform beam failure recovery. As another example, the UE may perform a small data transfer. As another example, the UE may perform initial access.

FIG. 9 is a diagram illustrating examples 900 and 905 of indication of a UE type of an RAR via RNTI differentiation, in accordance with the present disclosure.

As described elsewhere herein, the UE may receive an indication of whether an RAR is for a first UE type or for a second UE type. In example 900, the indication is, or is included in, a configuration of a RACH occasion. For example, the UE may receive configuration information indicating one or more first ROs, shown by reference number 910, and one or more second ROs, shown by reference number 915. The one or more first ROs may be for RARs of the first UE type, and the one or more second ROS may be for RARs of the second UE type. In this example, UEs of the first UE type and UEs of the second UE type may use the same formula to determine an RA-RNTI and a messageB-RNTI of the RAR. Furthermore, RARs responding to a RAM on the one or more first ROs may use a first RA-RNTI and/or messageB-RNTI of the one or more first ROs, and RARs responding to a RAM on the one or more second ROs may use a second RA-RNTI and/or messageB-RNTI of the one or more second ROs. Thus, a UE can determine, prior to decoding an RAR, whether the RAR is directed to the first UE type or the second UE type (according to a RA-RNTI or messageB-RNTI of the RAR), and can therefore proceed with decoding, or skip decoding, of the RAR.

In example 905, the indication is, or is included in, a configuration of a RACH occasion. For example, an RA-RNTI or messageB-RNTI for a first UE type may be configured with a first formula, and an RA-RNTI or MessageB-RNTI for a second UE type may be configured with a second formula different than the first formula. Therefore, an RAR can be configured with an RA-RNTI or a messageB-RNTI that is differentiable as for the first UE type or for the second UE type. In this example, the first UE type may have a first set of RNTIs 920 (e.g., a first RNTI space, a non-overlapping RNTI set), the second UE type may have a second set of RNTIs 925 (e.g., a second RNTI space, a non-overlapping RNTI set), and a third set of RNTIs 930 (e.g., a shared RNTI space) may be for the first UE type and the second UE type. Thus, by addressing an RAR to a RNTI belonging to one of the first set of RNTIs 920, the second set of RNTIs 925, or the third set of RNTIs 930, a network node can indicate whether the RAR is to be decoded by a UE of the first UE type, a UE of the second UE type, or both. For example, if an RAR is directed to only the second UE type or only the first UE type, the RA-RNTI and messageB-RNTI of the RAR may be selected from non-overlapping RNTI spaces (e.g., the first set of RNTIs 920 or the second set of RNTIs 925), whereas if an RAR is directed to both the first UE type and the second UE type, RA-RNTI and messageB-RNTI may be selected from the third set of RNTIs 930. In this way, the indication may indicate that the RAR is for both the first UE type and the second UE type if a RACH occasion of the RAR belongs to (e.g., being associated with an RNTI that is derived from the RACH occasion and belonging to) the shared RNTI space. In this way, the indication may indicate that the RAR is for one of the first UE type and the second UE type if a RACH occasion of the RAR belongs to (e.g., being associated with an RNTI that is derived from the RACH occasion and belonging to) the first set of RNTIs 920 or the second set of RNTIs 925.

FIG. 10 is a diagram illustrating an example 1000 of indication of a UE type for an RAR by RAR window differentiation, in accordance with the present disclosure. Example 1000 illustrates a first RAR window 1005 and a second RAR window 1010. A starting time and/or duration L1 of the first RAR window 1005 may be different than a starting time and/or duration L2 of the second RAR window 1010. An RAR window is a window in which a PDCCH communication scheduling a PDSCH communication carrying an RAR can arrive. A UE may receive, and a network node may output, configuration information indicating an RAR window for a UE. For example, the network node may configure UEs of the first UE type to use the first RAR window 1005, and/or may configure UEs of the second UE type to use the second RAR window 1010. Thus, a UE monitoring the first RAR window 1005 may receive only PDCCH communications scheduling RARs for a UE type of the first RAR window 1005, and a UE monitoring the second RAR window 1010 may receive only PDCCH communications scheduling RARs for a UE type of the second RAR window 1010. In some aspects, if the RAR windows 1005 and 1010 (corresponding to different UE types) overlap one another, as at reference number 1015, a PDCCH communication within the overlapping interval can schedule an RAR for only the first UE type. In some aspects, if the RAR windows 1005 and 1010 (corresponding to different UE types) overlap one another, as at reference number 1015, a PDCCH communication within the overlapping interval can schedule an RAR for only the second UE type. In some aspects, if the RAR windows 1005 and 1010 (corresponding to different UE types) overlap one another, as at reference number 1015, a PDCCH communication within the overlapping interval can schedule an RAR for the first UE type and the second UE type.

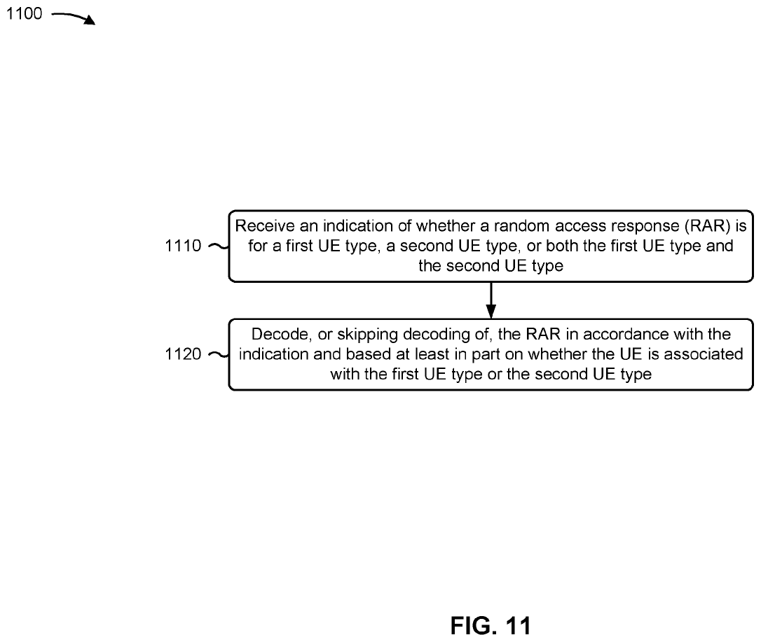

FIG. 11 shows a method 1100 for wireless communications by a UE, such as UE 120, in accordance with the present disclosure.

Method 1100 begins at 1110 with receiving an indication of whether an RAR is for a first UE type, a second UE type, or both the first UE type and the second UE type.

Method 1100 then proceeds to step 1120 with decoding, or skipping decoding of, the RAR in accordance with the indication and based at least in part on whether the UE is associated with the first UE type or the second UE type. As used herein, “decoding” includes extracting encoded information from a received signal, such as a received PDSCH communication carrying an RAR.

In a first aspect, the indication comprises a demodulation reference signal of a physical downlink control channel associated with the RAR.

In a second aspect, alone or in combination with the first aspect, the indication comprises a cyclic redundancy check of a downlink control information message associated with the RAR.

In a third aspect, alone or in combination with one or more of the first and second aspects, the indication comprises a field of a downlink control information message associated with the RAR.

In a fourth aspect, alone or in combination with one or more of the first through third aspects, the indication is a bit of a downlink control information message associated with the RAR.

In a fifth aspect, alone or in combination with one or more of the first through fourth aspects, the indication comprises a field of a downlink control information message, associated with the RAR, that is not valid for a UE type of the UE.

In a sixth aspect, alone or in combination with one or more of the first through fifth aspects, the indication comprises a configuration of a downlink control information message, associated with the RAR, that is not decodable by a UE type of the UE.

In a seventh aspect, alone or in combination with one or more of the first through sixth aspects, the indication comprises a configuration of a RACH occasion for a RACH preamble corresponding to the RAR.

In an eighth aspect, alone or in combination with one or more of the first through seventh aspects, the indication indicates that the RAR is for both the first UE type and the second UE type based at least in part on the RACH occasion belonging to a shared RNTI set.

In a ninth aspect, alone or in combination with one or more of the first through eighth aspects, the indication indicates that the RAR is for one of the first UE type or the second UE type based at least in part on the RACH occasion belonging to a non-overlapping RNTI set.

In a tenth aspect, alone or in combination with one or more of the first through ninth aspects, the indication comprises a configuration of an RAR window of the RAR.

In an eleventh aspect, alone or in combination with one or more of the first through tenth aspects, the indication comprises a physical downlink control channel communication in a control resource set that indicates whether the RAR is for the first UE type, the second UE type, or both the first UE type and the second UE type.

In a twelfth aspect, alone or in combination with one or more of the first through eleventh aspects, the indication comprises a physical downlink control channel communication in a search space set that indicates whether the RAR is for the first UE type, the second UE type, or both the first UE type and the second UE type.

In a thirteenth aspect, alone or in combination with one or more of the first through twelfth aspects, the indication comprises one or more parameters of a downlink bandwidth part configuration for random access.

In a fourteenth aspect, alone or in combination with one or more of the first through thirteenth aspects, the first UE type has a first bandwidth capability for receiving the RAR and the second UE type has a second bandwidth capability for receiving the RAR.

In a fifteenth aspect, alone or in combination with one or more of the first through fourteenth aspects, the first UE type is an enhanced mobile broadband (eMBB) or a reduced capability (RedCap) UE type, and the second UE type is an enhanced RedCap (eRedCap) UE type.

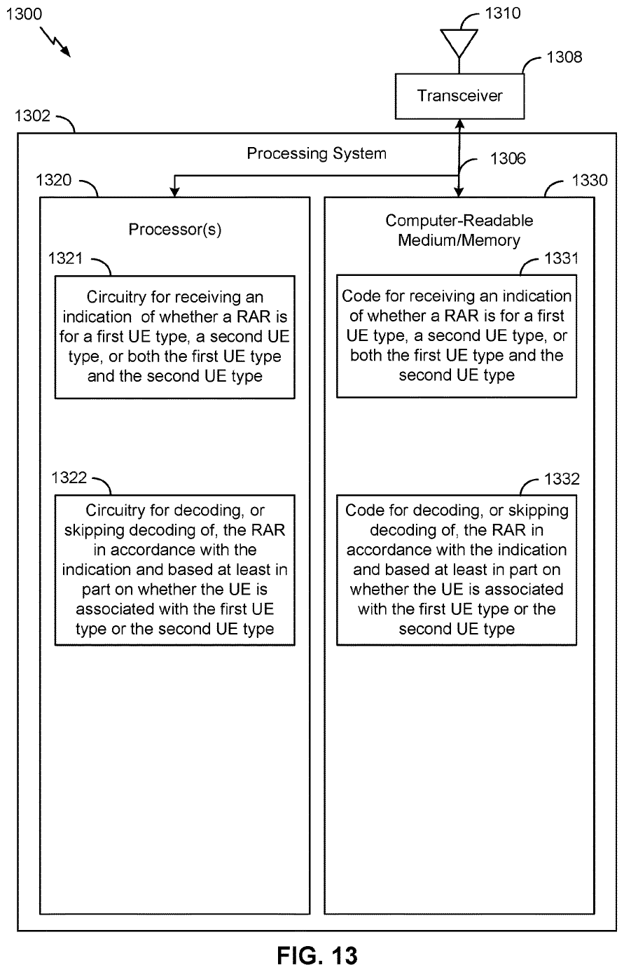

In one aspect, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative steps are possible consistent with this disclosure.

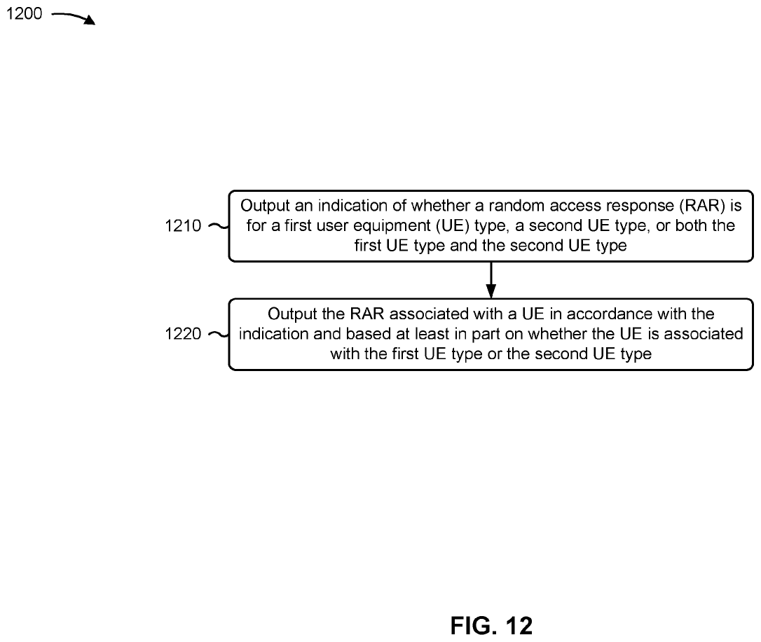

FIG. 12 shows a method 1200 for wireless communications by a network entity, such as BS 110, or a disaggregated base station as discussed with respect to FIG. 3, in accordance with the present disclosure.

Method 1200 begins at 1210 with outputting an indication of whether an RAR is for a first UE type, a second UE type, or both the first UE type and the second UE type.

Method 1200 then proceeds to step 1220 with outputting the RAR in accordance with the indication and based at least in part on whether the UE is associated with the first UE type or the second UE type. The outputting of the RAR based at least in part on whether the UE is associated with the first UE type or the second UE type may include, for example, outputting an RAR that conforms with a capability of the first UE type if the UE is associated with the first UE type, or that conforms with a capability of the second UE type, if the UE is associated with the second UE type.

In a first aspect, the indication comprises a demodulation reference signal of a physical downlink control channel associated with the RAR.

In a second aspect, alone or in combination with the first aspect, the indication comprises a cyclic redundancy check of a downlink control information message associated with the RAR.

In a third aspect, alone or in combination with one or more of the first and second aspects, the indication comprises a field of a downlink control information message associated with the RAR.

In a fourth aspect, alone or in combination with one or more of the first through third aspects, the indication is a bit of a downlink control information message associated with the RAR.

In a fifth aspect, alone or in combination with one or more of the first through fourth aspects, the indication comprises a field of a downlink control information message, associated with the RAR, that is not valid for a UE type of the UE.

In a sixth aspect, alone or in combination with one or more of the first through fifth aspects, the indication comprises a configuration of a downlink control information message, associated with the RAR, that is not decodable by a UE type of the UE.

In a seventh aspect, alone or in combination with one or more of the first through sixth aspects, the indication comprises a configuration of a RACH occasion for a RACH preamble corresponding to the RAR.

In an eighth aspect, alone or in combination with one or more of the first through seventh aspects, the indication indicates that the RAR is for both the first UE type and the second UE type based at least in part on the RACH occasion belonging to a shared RNTI set.

In a ninth aspect, alone or in combination with one or more of the first through eighth aspects, the indication indicates that the RAR is for one of the first UE type or the second UE type based at least in part on the RACH occasion belonging to a non-overlapping RNTI set.

In a tenth aspect, alone or in combination with one or more of the first through ninth aspects, the indication comprises a configuration of an RAR window of the RAR.

In an eleventh aspect, alone or in combination with one or more of the first through tenth aspects, the indication comprises a physical downlink control channel communication in a control resource set that indicates whether the RAR is for the first UE type, the second UE type, or both the first UE type and the second UE type.

In a twelfth aspect, alone or in combination with one or more of the first through eleventh aspects, the indication comprises a physical downlink control channel communication in a search space set that indicates whether the RAR is for the first UE type, the second UE type, or both the first UE type and the second UE type.

In a thirteenth aspect, alone or in combination with one or more of the first through twelfth aspects, the indication comprises one or more parameters of a downlink bandwidth part configuration for random access.

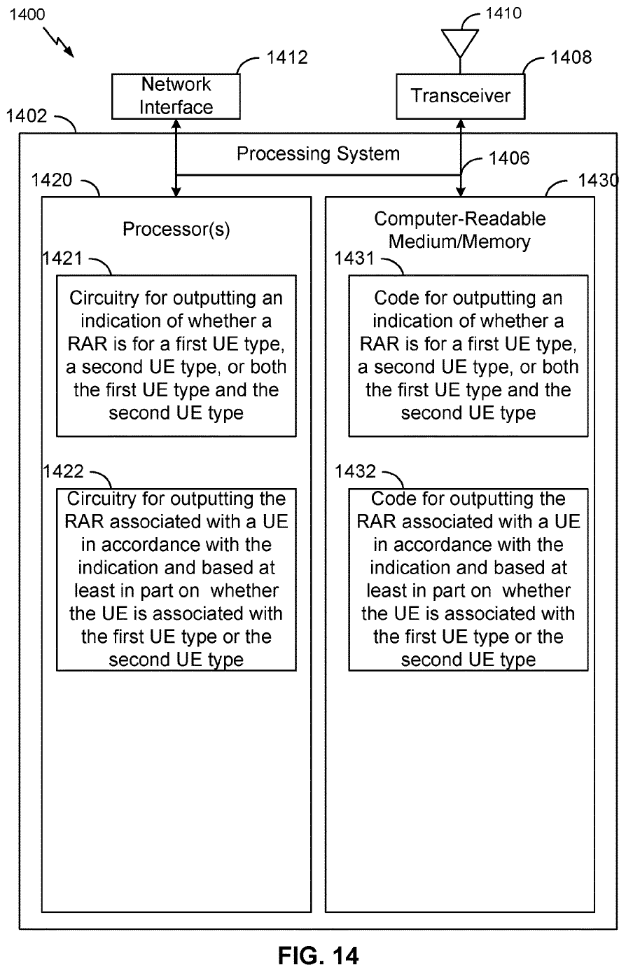

In one aspect, method 1200, or any aspect related to it, may be performed by an apparatus, such as communications device 1400 of FIG. 14, which includes various components operable, configured, or adapted to perform the method 1200. Communications device 1400 is described below in further detail.

Note that FIG. 12 is just one example of a method, and other methods including fewer, additional, or alternative steps are possible consistent with this disclosure.

FIG. 13 depicts aspects of an example communications device 1300, in accordance with the present disclosure. In some aspects, communications device 1300 is a user equipment, such as UE 120.

The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes one or more processors 1320. In various aspects, the one or more processors 1320 may be representative of one or more of receive processor 258, transmit processor 264, TX MIMO processor 266, and/or controller/processor 280, as described with respect to FIG. 2. The one or more processors 1320 are coupled to a computer-readable medium/memory 1330 via a bus 1306. In certain aspects, the computer-readable medium/memory 1330 is configured to store instructions (e.g., computer-executable code, processor-executable instructions) that when executed by the one or more processors 1320, cause the one or more processors 1320 to perform the method 1100 described with respect to FIG. 11, or any aspect related to it. Note that reference to a processor performing a function of communications device 1300 may include one or more processors performing that function of communications device 1300 In the depicted example, computer-readable medium/memory 1330 stores code (e.g., executable instructions) 1331 for receiving an indication of whether an RAR is for a first UE type, a second UE type, or both the first UE type and the second UE type and code 1332 for decoding, or skipping decoding of, the RAR in accordance with the indication and based at least in part on whether the UE is associated with the first UE type or the second UE type. Processing of the code 1331-1332 may cause the communications device 1300 to perform the method 1100 described with respect to FIG. 11, or any aspect related to it.

The one or more processors 1320 include circuitry configured to implement (e.g., execute) the code stored in the computer-readable medium/memory 1330, including circuitry 1321 for receiving an indication of whether an RAR is for a first UE type, a second UE type, or both the first UE type and the second UE type and circuitry 1322 for decoding, or skipping decoding of, the RAR in accordance with the indication and based at least in part on whether the UE is associated with the first UE type or the second UE type. Processing with circuitry 1321-1322 may cause the communications device 1300 to perform the method 1100 described with respect to FIG. 11, or any aspect related to it.

Various components of the communications device 1300 may provide means for performing the method 1100 described with respect to FIG. 11, or any aspect related to it. For example, means for transmitting, sending, or outputting for transmission may include the transceivers 254 and/or antenna(s) 252 of the UE 120 and/or transceiver 1308 and antenna 1310 of the communications device 1300 in FIG. 13. Means for receiving or obtaining may include the transceivers 254 and/or antenna(s) 252 of the UE 120 and/or transceiver 1308 and antenna 1310 of the communications device 1300 in FIG. 13.

FIG. 14 depicts aspects of an example communications device 1400, in accordance with the present disclosure. In some aspects, communications device 1400 is a network entity, such as BS 110, or a disaggregated base station as discussed with respect to FIG. 3.

The communications device 1400 includes a processing system 1402 coupled to a transceiver 1408 (e.g., a transmitter and/or a receiver) and/or a network interface 1412. The transceiver 1408 is configured to transmit and receive signals for the communications device 1400 via an antenna 1410, such as the various signals as described herein. The network interface 1412 is configured to obtain and send signals for the communications device 1400 via communications link(s), such as a backhaul link, midhaul link, and/or fronthaul link as described herein, such as with respect to FIG. 3. The processing system 1402 may be configured to perform processing functions for the communications device 1400, including processing signals received and/or to be transmitted by the communications device 1400.

The processing system 1402 includes one or more processors 1420. In various aspects, one or more processors 1420 may be representative of one or more of receive processor 238, transmit processor 220, TX MIMO processor 230, and/or controller/processor 240, as described with respect to FIG. 2. The one or more processors 1420 are coupled to a computer-readable medium/memory 1430 via a bus 1406. In certain aspects, the computer-readable medium/memory 1430 is configured to store instructions (e.g., computer-executable code) that when executed by the one or more processors 1420, cause the one or more processors 1420 to perform the method 1200 described with respect to FIG. 12, or any aspect related to it. Note that reference to a processor of communications device 1400 performing a function may include one or more processors of communications device 1400 performing that function.

In the depicted example, the computer-readable medium/memory 1430 stores code (e.g., executable instructions) 1431 for outputting an indication of whether an RAR is for a first UE type, a second UE type, or both the first UE type and the second UE type and code 1432 for outputting the RAR associated with a UE in accordance with the indication and based at least in part on whether the UE is associated with the first UE type or the second UE type. Processing of the code 1431-1432 may cause the communications device 1400 to perform the method 1200 described with respect to FIG. 12, or any aspect related to it.

The one or more processors 1420 include circuitry configured to implement (e.g., execute) the code stored in the computer-readable medium/memory 1430, including circuitry 1421 for outputting an indication of whether an RAR is for a first UE type, a second UE type, or both the first UE type and the second UE type and circuitry 1422 for outputting the RAR associated with a UE in accordance with the indication and based at least in part on whether the UE is associated with the first UE type or the second UE type. Processing with circuitry 1421-1422 may cause the communications device 1400 to perform the method 1200 as described with respect to FIG. 12, or any aspect related to it.

Various components of the communications device 1400 may provide means for performing the method 1200 as described with respect to FIG. 12, or any aspect related to it. Means for transmitting, sending, or outputting for transmission may include the transceivers 232 and/or antenna(s) 234 of the BS 110 and/or transceiver 1408 and antenna 1410 of the communications device 1400 in FIG. 14. Means for receiving or obtaining may include the transceivers 232 and/or antenna(s) 234 of the BS 110 and/or transceiver 1408 and antenna 1410 of the communications device 1400 in FIG. 14.

The following provides an overview of some Aspects of the present disclosure:
Aspect 1: A method of wireless communication performed by a user equipment (UE), comprising: receiving an indication of whether a random access response (RAR) is for a first UE type, a second UE type, or both the first UE type and the second UE type; and decoding, or skipping decoding of, the RAR in accordance with the indication and based at least in part on whether the UE is associated with the first UE type or the second UE type.
Aspect 2: The method of Aspect 1, wherein the indication comprises a demodulation reference signal of a physical downlink control channel associated with the RAR.
Aspect 3: The method of any of Aspects 1-2, wherein the indication comprises a cyclic redundancy check of a downlink control information message associated with the RAR.
Aspect 4: The method of any of Aspects 1-3, wherein the indication comprises a field of a downlink control information message associated with the RAR.
Aspect 5: The method of any of Aspects 1-4, wherein the indication is a bit of a downlink control information message associated with the RAR.
Aspect 6: The method of any of Aspects 1-5, wherein the indication comprises a field of a downlink control information message, associated with the RAR, that is not valid for a UE type of the UE.
Aspect 7: The method of any of Aspects 1-6, wherein the indication comprises a configuration of a downlink control information message, associated with the RAR, that is not decodable by a UE type of the UE.
Aspect 8: The method of any of Aspects 1-7, wherein the indication comprises a configuration of a random access channel (RACH) occasion for a RACH preamble corresponding to the RAR.
Aspect 9: The method of Aspect 8, wherein the indication indicates that the RAR is for both the first UE type and the second UE type based at least in part on the RACH occasion belonging to a shared radio network temporary identifier (RNTI) set.
Aspect 10: The method of Aspect 8, wherein the indication indicates that the RAR is for one of the first UE type or the second UE type based at least in part on the RACH occasion belonging to a non-overlapping radio network temporary identifier (RNTI) set.
Aspect 11: The method of any of Aspects 1-11, wherein the indication comprises a configuration of an RAR window of the RAR.
Aspect 12: The method of any of Aspects 1-12, wherein the indication comprises a physical downlink control channel communication in a control resource set that indicates whether the RAR is for the first UE type, the second UE type, or both the first UE type and the second UE type.
Aspect 13: The method of any of Aspects 1-13, wherein the indication comprises a physical downlink control channel communication in a search space set that indicates whether the RAR is for the first UE type, the second UE type, or both the first UE type and the second UE type.
Aspect 14: The method of any of Aspects 1-14, wherein the indication comprises one or more parameters of a downlink bandwidth part configuration for random access.
Aspect 15: The method of any of Aspects 1-15, wherein the first UE type has a first bandwidth capability for receiving the RAR and the second UE type has a second bandwidth capability for receiving the RAR.
Aspect 16: The method of Aspect 15, wherein the first UE type is an enhanced mobile broadband (eMBB) or a reduced capability (RedCap) UE type, and the second UE type is an enhanced RedCap (eRedCap) UE type.
Aspect 17: A method of wireless communication performed by a network entity, comprising: outputting an indication of whether a random access response (RAR) is for a first user equipment (UE) type, a second UE type, or both the first UE type and the second UE type; and outputting the RAR associated with a UE in accordance with the indication and based at least in part on whether the UE is associated with the first UE type or the second UE type.
Aspect 18: The method of Aspect 17, wherein the indication comprises a demodulation reference signal of a physical downlink control channel associated with the RAR.
Aspect 19: The method of any of Aspects 17-18, wherein the indication comprises a cyclic redundancy check of a downlink control information message associated with the RAR.
Aspect 20: The method of any of Aspects 17-19, wherein the indication comprises a field of a downlink control information message associated with the RAR.
Aspect 21: The method of any of Aspects 17-20, wherein the indication is a bit of a downlink control information message associated with the RAR.
Aspect 22: The method of any of Aspects 17-21, wherein the indication comprises a field of a downlink control information message, associated with the RAR, that is not valid for a UE type of the UE.
Aspect 23: The method of any of Aspects 17-22, wherein the indication comprises a configuration of a downlink control information message, associated with the RAR, that is not decodable by a UE type of the UE.
Aspect 24: The method of any of Aspects 17-23, wherein the indication comprises a configuration of a random access channel (RACH) occasion for a RACH preamble corresponding to the RAR.
Aspect 25: The method of Aspect 24, wherein the indication indicates that the RAR is for both the first UE type and the second UE type based at least in part on the RACH occasion belonging to a shared radio network temporary identifier (RNTI) set.
Aspect 26: The method of Aspect 24, wherein the indication indicates that the RAR is for one of the first UE type or the second UE type based at least in part on the RACH occasion belonging to a non-overlapping radio network temporary identifier (RNTI) set.
Aspect 27: The method of any of Aspects 17-26, wherein the indication comprises a configuration of an RAR window of the RAR.
Aspect 28: The method of any of Aspects 17-27, wherein the indication comprises a physical downlink control channel communication in a control resource set that indicates whether the RAR is for the first UE type, the second UE type, or both the first UE type and the second UE type.
Aspect 29: The method of any of Aspects 17-28, wherein the indication comprises a physical downlink control channel communication in a search space set that indicates whether the RAR is for the first UE type, the second UE type, or both the first UE type and the second UE type.
Aspect 30: The method of any of Aspects 17-29, wherein the indication comprises one or more parameters of a downlink bandwidth part configuration for random access.
Aspect 31: An apparatus for wireless communication at a device, comprising a processor; memory coupled with the processor; and instructions stored in the memory and executable by the processor to cause the apparatus to perform the method of one or more of Aspects 1-30.
Aspect 32: A device for wireless communication, comprising a memory and one or more processors coupled to the memory, the one or more processors configured to perform the method of one or more of Aspects 1-30.
Aspect 33: An apparatus for wireless communication, comprising at least one means for performing the method of one or more of Aspects 1-30.
Aspect 34: A non-transitory computer-readable medium storing code for wireless communication, the code comprising instructions executable by a processor to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method of wireless communication performed by a user equipment (UE), comprising:
receiving an indication of whether a random access response (RAR) is for a first UE type, a second UE type, or both the first UE type and the second UE type; and
decoding, or skipping decoding of, the RAR in accordance with the indication and based at least in part on whether the UE is associated with the first UE type or the second UE type.

2. The method of claim 1, wherein the indication comprises a demodulation reference signal of a physical downlink control channel associated with the RAR.

3. The method of claim 1, wherein the indication comprises a cyclic redundancy check of a downlink control information message associated with the RAR.

4. The method of claim 1, wherein the indication comprises a field of a downlink control information message associated with the RAR.

5. The method of claim 1, wherein the indication is a bit of a downlink control information message associated with the RAR.

6. The method of claim 1, wherein the indication comprises a field of a downlink control information message, associated with the RAR, that is not valid for a UE type of the UE.

7. The method of claim 1, wherein the indication comprises a configuration of a downlink control information message, associated with the RAR, that is not decodable by a UE type of the UE.

8. The method of claim 1, wherein the indication comprises a configuration of a random access channel (RACH) occasion for a RACH preamble corresponding to the RAR.

9. The method of claim 8, wherein the indication indicates that the RAR is for both the first UE type and the second UE type based at least in part on the RACH occasion belonging to a shared radio network temporary identifier (RNTI) set.

10. The method of claim 8, wherein the indication indicates that the RAR is for one of the first UE type or the second UE type based at least in part on the RACH occasion belonging to a non-overlapping radio network temporary identifier (RNTI) set.

11. The method of claim 1, wherein the indication comprises a configuration of an RAR window of the RAR.

12. The method of claim 1, wherein the indication comprises a physical downlink control channel communication in a control resource set that indicates whether the RAR is for the first UE type, the second UE type, or both the first UE type and the second UE type.

13. The method of claim 1, wherein the indication comprises a physical downlink control channel communication in a search space set that indicates whether the RAR is for the first UE type, the second UE type, or both the first UE type and the second UE type.

14. The method of claim 1, wherein the indication comprises one or more parameters of a downlink bandwidth part configuration for random access.

15. The method of claim 1, wherein the first UE type has a first bandwidth capability for receiving the RAR and the second UE type has a second bandwidth capability for receiving the RAR.

16. The method of claim 15, wherein the first UE type is an enhanced mobile broadband (eMBB) or a reduced capability (RedCap) UE type, and the second UE type is an enhanced RedCap (eRedCap) UE type.

17-28. (canceled)

29. A user equipment (UE), comprising: a memory comprising processor-executable instructions; and a processor configured to execute the processor-executable instructions and cause the UE to:
receive an indication of whether a random access response (RAR) is for a first UE type, a second UE type, or both the first UE type and the second UE type; and
decode, or skip decoding of, the RAR in accordance with the indication and based at least in part on whether the UE is associated with the first UE type or the second UE type.

30. A network entity, comprising: a memory comprising processor-executable instructions; and a processor configured to execute the processor-executable instructions and cause the network entity to:
output an indication of whether a random access response (RAR) is for a first user equipment (UE) type, a second UE type, or both the first UE type and the second UE type; and
output the RAR associated with a UE in accordance with the indication and based at least in part on whether the UE is associated with the first UE type or the second UE type.

31. The network entity of claim 30, wherein:
the indication comprises a demodulation reference signal of a physical downlink control channel associated with the RAR; or
the indication comprises a cyclic redundancy check of a downlink control information message associated with the RAR; or
the indication comprises a field of a downlink control information message associated with the RAR; or
the indication is a bit of a downlink control information message associated with the RAR; or
the indication comprises a field of a downlink control information message, associated with the RAR, that is not valid for a UE type of the UE; or
the indication comprises a configuration of a downlink control information message, associated with the RAR, that is not decodable by a UE type of the UE; or
the indication comprises a configuration of a random access channel (RACH) occasion for a RACH preamble corresponding to the RAR; or
the indication comprises a configuration of an RAR window of the RAR; or
the indication comprises a physical downlink control channel communication in a control resource set that indicates whether the RAR is for the first UE type, the second UE type, or both the first UE type and the second UE type.

32. The UE of claim 29, wherein:
the indication comprises a demodulation reference signal of a physical downlink control channel associated with the RAR; or
the indication comprises a cyclic redundancy check of a downlink control information message associated with the RAR; or
the indication comprises a field of a downlink control information message associated with the RAR; or
the indication is a bit of a downlink control information message associated with the RAR; or
the indication comprises a field of a downlink control information message, associated with the RAR, that is not valid for a UE type of the UE; or
the indication comprises a configuration of a downlink control information message, associated with the RAR, that is not decodable by a UE type of the UE; or
the indication comprises a configuration of a random access channel (RACH) occasion for a RACH preamble corresponding to the RAR; or
the indication comprises a configuration of an RAR window of the RAR; or
the indication comprises a physical downlink control channel communication in a control resource set that indicates whether the RAR is for the first UE type, the second UE type, or both the first UE type and the second UE type; or
the indication comprises a physical downlink control channel communication in a search space set that indicates whether the RAR is for the first UE type, the second UE type, or both the first UE type and the second UE type; or
the indication comprises one or more parameters of a downlink bandwidth part configuration for random access; or
the first UE type has a first bandwidth capability for receiving the RAR and the second UE type has a second bandwidth capability for receiving the RAR; or
the first UE type is an enhanced mobile broadband (eMBB) or a reduced capability (RedCap) UE type, and the second UE type is an enhanced RedCap (eRedCap) UE type.
